(19) United States
(12) Patent Application Publication
(10) Pub. No.: US 2026/0230306 A1
(43) Pub. Date: Aug. 6, 2026

(54) METHOD AND ELECTRONIC DEVICE FOR COMMUNICATION IN BLOCKCHAIN NETWORK

(71) Applicant: SAMSUNG ELECTRONICS CO., LTD., Suwon-si (KR)

(72) Inventors: Moehammad Dzaky Fauzan MA’AS, Jakarta (ID); Benaldy Yuga ADHAITYAR, Jakarta (ID); James ALEXANDER, Jakarta (ID); Arnold SIANTURI, Jakarta (ID); Abhi Satria WISESA, Jakarta (ID)

(73) Assignee: SAMSUNG ELECTRONICS CO., LTD., Suwon-si (KR)

(21) Appl. No.: 19/149,258

(22) PCT Filed: Jan. 18, 2024
(86) PCT No.: PCT/KR2024/000920

§ 371 Date: Jul. 18, 2025

(30) Foreign Application Priority Data
Jan. 19, 2023 (ID) P00202300569

(51) Int. Cl. H04L 9/08; H04L 9/00; H04L 9/32

(52) U.S. Cl. CPC H04L 9/0825; H04L 9/3236; H04L 9/50

(57) ABSTRACT

A method for communication by an electronic device in a blockchain network is provided. The method comprises obtaining input data; filtering the input data for removing private data from the input data, based on privacy policy agreements; obtaining a public key, a private key and a proof key; generating an output proof of signing data based on the filtered input data, the public key, the private key and the proof key; and transmitting the output proof to a target network.

### CROSS-REFERENCE TO RELATED APPLICATIONS

This application is a U.S. National Phase Entry of PCT/KR2024/000920, filed on Jan. 18, 2024, in the Korean Intellectual Property Receiving Office, which is based on and claims priority to Indonesian Patent Application No. P00202300569, filed on Jan. 19, 2023, in the Indonesian Directorate General of Intellectual Property, the disclosures of which are incorporated by reference herein in their entireties.

### BACKGROUND

### 1. Field

The present disclosure relates generally to a method and an electronic device for communication in a blockchain network, and more specifically, to securing private data in the blockchain network.

### 2. Description of Related Art

Personal data has become a new commodity as the adoption to digital services is increasing rapidly. One downside is personal data leakage that has occurred to billions of accounts, breached by irresponsible parties. This indicates that the current data security systems still need improvements in order to build a more secure system. Blockchain has received extensive attention and rapid growth of its adoption in numerous industry fields. This technology has desirable features of a decentralized system that provides immutability, fault-tolerance, and transparency. Those features earn the blockchain architecture a spot among the most secure database ever created. When a transaction is made, blockchain can preserve a certain amount of privacy through the public key and private key without any real identity exposure. Because a purpose of the system is transparency and the values of all transactions for each public key are publicly visible, blockchain cannot guarantee the transactional privacy. Therefore, a fully anonymous system is needed to guarantee transactional privacy, and also ensuring data validity in order to make the system more secure.

Nevertheless, the implementation of blockchain still faces some critical issues regarding security. One example is the implementation of blockchain for online electronic voting system (e-voting) in Russia. Based on published news and views from experts, an e-voting system in Russia used an encryption scheme called ElGamal, and there were reported incidents in which the encryption was able to be easily broken in approximately twenty minutes using a standard personal computer and using only free software that is publicly available. Additionally, there are some reports that over a million pieces of personal data in Russia were leaked due to this incident. The data allegedly belongs to some of the citizens who participated in the recent blockchain-based e-voting event. These issues indicated that blockchain still has some problems in providing privacy and security of the data.

Based on the issues above, zero knowledge proofs could be a suitable solution to the privacy issue. Zero knowledge proof is a method where one party (prover) can prove to another party (verifier) that a given statement is true while the prover avoids conveying any additional information apart from the fact that the statement is indeed true. The essence of zero knowledge proof is that it is trivial to prove that one possesses knowledge of certain information by simply revealing it. The challenge is to prove such possession without revealing the information itself or any additional information. This ability of zero knowledge proof allows systems to verify the ownership and validity of the data without revealing any additional information that can be dangerous when exposed.

The use of embedded Secure Element (eSE) chips is also increasing, and some eSE chips may already be embedded in mobile devices, such as smartphones. These eSE chips may be used to ensure that data is stored safely. The information is only shared with authorized applications and people because of restricted access to the chip ensures strong secure protection to the element.

There are already several patents and public papers that explore various method for improving security and privacy in blockchain technology such as hashing key, pseudonymous mixing, graph analysis preventer, and others. However, none of the disclosures discussed methods on how to leverage all of these topics into an intelligent system that automatically perform to solve privacy and verification in one single process.

### SUMMARY

Provided is method and system for securing data privacy in verification procedure using Blockchain application and utilizing the ability of eSE. Embodiments may provide a solution to overcome the security and privacy problem and can be adopted in any system that needs a use of data collection and/or digital action, including data transmission, on smart devices without the need of the raw content of the data.

Also provided are methods and systems for securing private data without the need to read the private data explicitly during a verification procedure in blockchain network.

Also provided is an Intelligent Anonymizing System and network verification, combined with the use of embedded Secure Element (eSE) and zero knowledge proof method. Therefore, embodiments may help to control sensitive data and protect user's credentials.

Also provided are methods and systems for securing data privacy in verification procedure using Blockchain application and utilizing the ability of eSE. This proposed disclosure can be a solution to overcome the security and privacy problem and can be adopted in any system that needs a use of data collection and/or digital action, including data transmission, on smart devices without the need of the raw content of the data.

According to an embodiment of the present disclosure, a method for communication by an electronic device in a blockchain network is provided. The method may include obtaining input data. The method may include filtering the input data to remove private data from the input data, based on privacy policy agreements. The method may include obtaining a public key, a private key, and a proof key. The method may include generating an output proof corresponding to signing data based on the filtered input data, the public key, the private key, and the proof key. The method may include transmitting the output proof to a target network.

Obtaining the public key, the private key and the proof key may include determining whether the public key, the private key and the proof key are stored in an embedded secured element (eSE) included in the electronic device; based on determining that the public key, the private key, and the proof key are stored in the eSE, obtaining the public key, the private key and the proof key from the eSE; and based on determining that the public key, the private key, and the proof key are not stored in the eSE, transmitting a registration request to the target network, receiving the public key, the private key, and the proof key from the target network based on a registration to the target network, and storing the received public key, the received private key, and the received proof key in the eSE.

The proof key may be generated using a Lambda function based on a verification key.

Generating the output proof of the signing data may include hashing the filtered input data; and generating the signing data by signing the hashed filtered input data using the private key.

Generating the output proof of the signing data may include generating a signing data polynomial based on the signing data and a Merkle proof polynomial based on a Merkle proof using a quadratic arithmetic program (QAP); generating a signing data proof and a Merkle proof proof based on the signing data polynomial and the Merkle proof polynomial using a Pinocchio Protocol, wherein the output proof includes the signing data proof and the Merkle proof proof.

The output proof of the signing data may be generated using an embedded secured element (eSE) included in the electronic device.

Filtering the input data may include identifying personal identifiable information (PII) from the input data; validating the identified PII based on a comparison between the identified PII and established PII; and removing the validated PII from the input data.

According to an embodiment of the present disclosure, an electronic device for communication in a blockchain network is provided. The electronic device may include at least one processor; and a memory storing instructions storing instructions which, when executed by the at least one processor, cause the electronic device to perform operations. The operations may include obtaining input data. The operations may include filtering the input data for removing private data from the input data, based on privacy policy agreements. The operations may include obtaining a public key, a private key, and a proof key. The operations may include generating an output proof corresponding to signing data based on the filtered input data, the public key, the private key and the proof key. The operations may include transmitting the output proof to a target network.

According to an embodiment of the present disclosure, a non-transitory computer readable storage medium storing instructions is provided. The instructions, when executed by at least one processor of an electronic device, cause the electronic device to perform operations. The operations may include obtaining input data. The operations may include filtering the input data for removing private data from the input data, based on privacy policy agreements. The operations may include obtaining a public key, a private key and a proof key. The operations may include generating an output proof of signing data based on the filtered input data, the public key, the private key, and the proof key. The operations may include transmitting the output proof to a target network.

Embodiments of the present disclosure may implement privacy policy agreements to filter and remove ineligible data that are considered as private data, by conditioning the input data through equation of data characteristics to standardize different types of data, defining the rules to determine which data considered as personal information and established the Personal Identifiable Information (PII) for PII model initialization, identifying PII based on the Privacy Policy Agreements by scanning the input data to identify which part of data to be considered as PII, and deleting the validated PII to produce clean data

Embodiments of the present disclosure may generate proof key and verification key that will be stored in eSE, and encrypt the data as private key using the specified algorithm, by registering the device to the targeted network if private key and public key are not available, calling lambda function to generate proof key for verification process, and creating and storing predefined ID in eSE when the keys are created.

Embodiments of the present disclosure may verify the eligibility of encrypted data using zero knowledge proof by processing and combining data and private key to form encrypted data, checking signing data to ensure the data sender has been validated, checking whether the data is part of a blockchain network using Merkle Proof, converting the signing data and Merkle Proofs to polynomial using Quadratic Arithmetic Program, and generating proof using Pinocchio protocol for verification process.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is the overall system scope for securing data privacy in verification procedure using blockchain application methods in accordance with the present disclosure;

FIG. 2A and FIG. 2B are the main flow diagram for Intelligent Anonymizing System;

FIG. 3 is a sample use case scenario for using Intelligent Anonymizing System

for electronic voting (e-voting);

FIG. 4 is the process of Intelligent Anonymizing System for E-voting;

FIG. 5 is a sample use case scenario for using Intelligent Anonymizing System

for health application;

FIG. 6 is the process of Intelligent Anonymizing System for health application;

FIG. 7 is a sample use case scenario for using Intelligent Anonymizing System for online advertising;

FIG. 8 is a sample use case scenario for using Intelligent Anonymizing System for IoT (Internet of Things) application;

FIG. 9 is a sample use case scenario for using Intelligent Anonymizing System

for autonomous automobiles;

FIG. 10 is a sample use case scenario for using Intelligent Anonymizing System for online donation;

FIG. 11 is a sample use case scenario for using Intelligent Anonymizing System

for anonymous feedback;

FIG. 12 is a sample use case scenario for using Intelligent Anonymizing System for online ticket purchase for events;

FIG. 13 is a sample use case scenario for using Intelligent Anonymizing System for mortgage application;

FIG. 14 is a sample use case scenario for using Intelligent Anonymizing System

for Vaccine Check Portal;

FIG. 15 is a sample use case scenario for using Intelligent Anonymizing System

for Metaverse identity;

FIG. 16 is the Intelligent Anonymizing System diagram;

FIG. 17 is the Privacy Data Filter module main diagram;

FIG. 18 is the flow diagram for PII validation process;

FIG. 19A and FIG. 19B are the example of data filtering process in simple list form and JSON object form;

FIG. 20 is the Key Generator module main diagram;

FIG. 21 is the flow diagram for Key Checker;

FIG. 22 is the flow diagram for checking process of network registration procedure;

FIG. 23 is the flow diagram for network registration procedure;

FIG. 24 is the Lambda function diagram;

FIG. 25 is the flow diagram for Calling Lambda Function from targeted network procedure;

FIG. 26 is the flow diagram of Save Key to eSE procedure'

FIG. 27 is the Anonymous Combinatory Data module main diagram;

FIG. 28 is the Signing Data Process diagram;

FIG. 29 is the Merkle Proof process diagram;

FIG. 30 is the example of Merkle Proof Process;

FIG. 31 is the QAP Process diagram;

FIG. 32 is the implement QAP with Smart Contract diagram;

FIG. 33 is the Generate Proof Process diagram;

FIG. 34 is the Data Verification module main diagram;

FIG. 35 is insert new data to targeted network diagram;

FIG. 36 is verification process with smart contract diagram; and

FIG. 37 shows a block diagram of an electronic device of the present disclosure.

### DETAILED DESCRIPTION

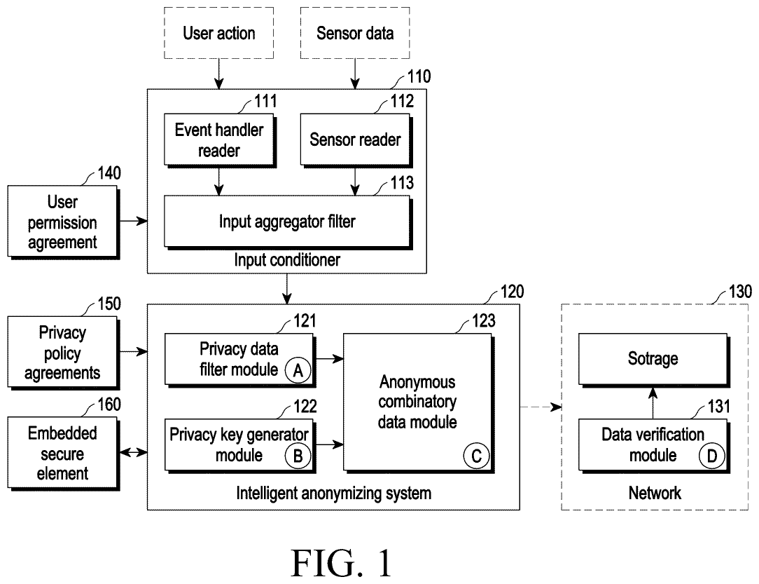

Preferred embodiments and their advantages are best understood by reference to FIGS. 1 through 37. Accordingly, it is to be understood that the embodiments of the disclosure herein described are merely illustrative of the application of the principles of the disclosure. Reference herein to details of the illustrated embodiments is not intended to limit the scope of the claims, which themselves recite those features regarded as essential to the disclosure.

FIG. 1 illustrates an example of the overall system scope for securing data privacy in verification procedure using blockchain application methods, which may hereinafter be referred as Intelligent Anonymizing System, in accordance with the present disclosure is shown. As shown in FIG. 1, embodiments work by relying on user's action, sensor data, and the system according to embodiments. User input, application data, and device performance data are examples of actions made by the user. The sensor data are collected by device's sensor system used for sensing any phenomenon or actions related to the user's device. The system may include three main processes. The first process is user input collection by input conditioner (110). The function of input conditioner (110) is to aggregate and standardized the collection of data using an event handler reader (111), a sensor reader (112), and anonymous combinatory data module (123). The event handler reader (111) is a program that may recognize and record events from user action, while the sensor reader (112) is a program that may record data from device sensor system. User permission agreement (140) is also needed as the agreement between the user and the system that user's device input may be used and some data may be collected. These data may be used in the next process.

The second process is performed by the intelligent anonymizing system (120). During the second process, the data are filtered, the keys are generated, and the proof data is created before the data sent to the target network (130). There are two components involved in this process. First is privacy policy agreements (150), as the policy or legal statement that the user must agree to, to notify that their data need to be collected. Second is embedded secure element (eSE) (160), as the built-in component of user device to save sensitive information of the device owner. The eSE (160) may function as a storage of the credential keys for the next process. The intelligent anonymizing system (120) may include a privacy data filter module (121), used for filtering and removing data that are considered as ineligibly private through the privacy policy agreements. The intelligent anonymizing system (120) may include a private key generator module (122), used for generating pairing keys, which consist of proof key and verification key, and storing both keys to eSE (160). The intelligent anonymizing system (120) may include an anonymous combinatory data module (123), used for generating proof data or statement using the keys and specified algorithm. The target network may include a data verification module (131). The data verification module (131) is used for verifying the proof statement created from the intelligent anonymizing system (120), and checking the eligibility of the data using Zero Knowledge process.

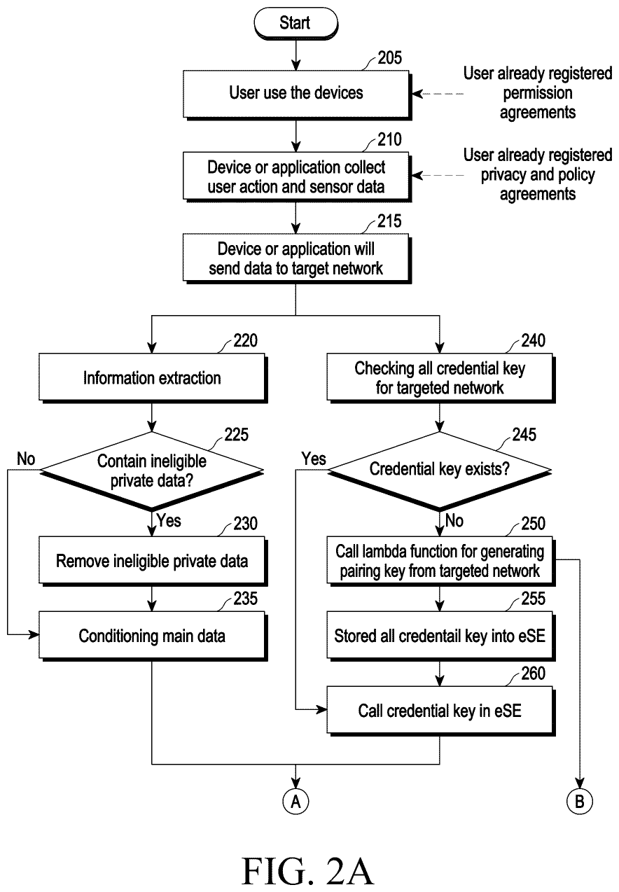

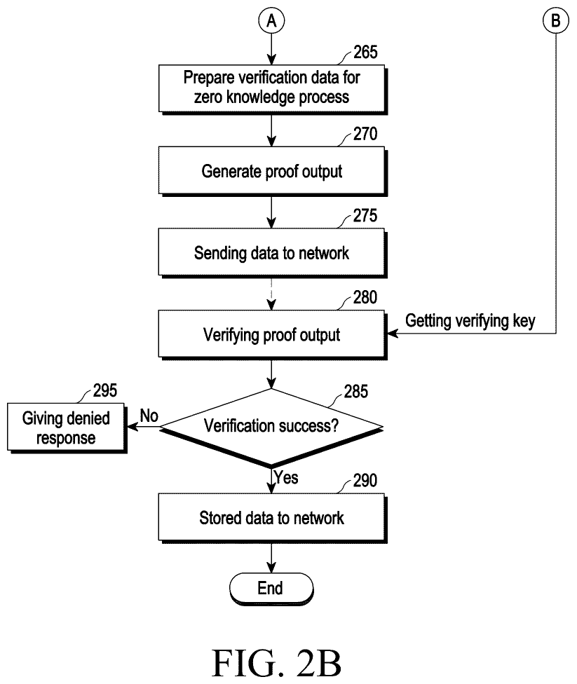

FIG. 2a and FIG. 2b illustrate an example of the main flow diagram of a system according to embodiments. At step 205, user use devices or applications from the devices, under the condition of data collecting permission and privacy policy agreements had been agreed by the user. At step 210, the device or the application collect the user action or the data sensor. At step 215, the device or the application prepares to send the collected data to the target network. The content of the data may be in generalized form and ready to be checked. The checking process may be separated into data extraction and credential keys checking. At step 220, data or information extraction is performed to filter ineligible data considered as private data which user do not want to be shared. At step 225, it is determined whether the extracted data or information contains ineligible private data. At step 230 the ineligible private data is removed, if it is determined that the extracted data or information contains the ineligible private data. At step 235, the eligible data is conditioned, i.e. be prepared to be sent for the next step. At step 240, credential keys for the targeted network is checked to ensure the user's device has private and public keys. At step 245, it is determined whether the credential keys exits. If not, the private and public keys is generated. At step 250, after the generated keys are available, the system may then call the Lambda Function to generate proof and verification keys, for the purpose of verification process. At step 255 private, public, and proof keys may be stored and saved in eSE of user's device, while verification key may be used later for verification process and send it over the network. At step 260, the credential key in the eSE is called. At step 265, the device prepares data for the proof output process (Merkle proof and Signing Data). At step 270, the data that has been prepared is then processed using a proof key to produce a proof output. Later, the proof output may be verified with the help of verifying key (that had been generated before) and verification function of the system, without the need of user privacy data. If the verification process produces valid and verified proof at step 285, the data which was sent at step 270, is stored to the network at step 290. If not at step 285, the system may return response about the unverified proof at step 295. Next, the device may prepare data for the proof output process using Merkle proof and Signing Data. The data that has been prepared is then processed using a proof key to produce a proof output. Later, the proof output may be verified with the help of verifying key that had been generated before and verification function of the system, without the need of user privacy data. If the verification process produces valid and verified proof, the data is sent and stored to the network. If not, the system may return response about the unverified proof.

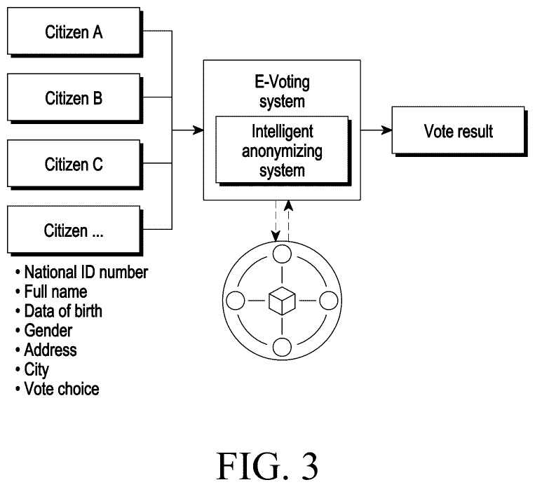

FIG. 3 through FIG. 15 illustrate examples of the various use cases in which embodiments of the disclosure can be implemented. Embodiments of the disclosure could be used in various situations that utilize technology that need to collect data, utilize Intelligent Anonymizing System and network verification, and store data on embedded Secure Element (eSE) on devices. As described previously, the system may collect data of the device and remove ineligible private data before sending it to the network. Embodiments of the disclosure would be able to obtain data from users transparently but also maintain user's anonymity in various activities.

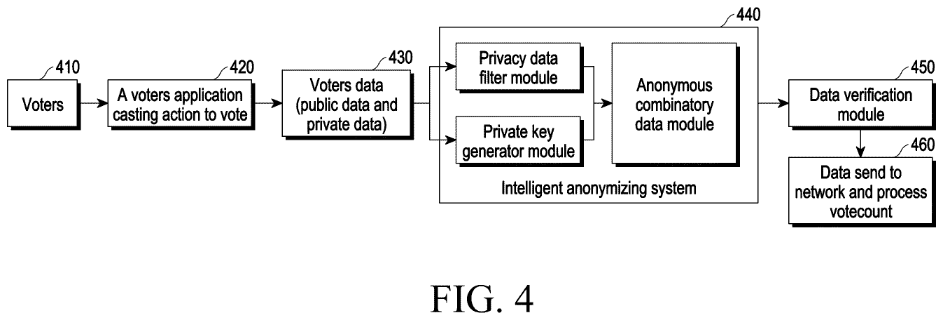

FIG. 3 and FIG. 4 illustrate examples of the user scenario of using Intelligent Anonymizing System for e-voting via internet. FIG. 3 illustrates the scenario when a user is using the e-voting system. Example scenario is election for new governor using e-voting system in City A. Citizens of City A can cast their vote through their smartphone at home. However, the use of e-voting brings a new worry for leak of private data, such as National ID number, full name, date of birth, etc. These data can be used by irresponsible people for their own advantage, for example applying for P2P lending through fintech application using the victim's data. E-voting may be implemented using a front end—voters and device, a middle—server to store the ballot data, and back end—to count the votes. Every point has the potential for security loophole, but the front end is the most vulnerable for attack from hackers. A system according to embodiments may be able to secure the private data from any leak or hack, and also guarantees transparent result. For this case, e-voting system may collect voting data, city, age, national identity number, full name and etc. FIG. 4 illustrates the flow of process when the Intelligent Anonymizing System is implemented to e-voting system. The process starts with citizens login to the e-voting portal and input their National ID number, name and date of birth for verification process (410). Then, citizens can cast their vote through application or website (420). The system may process the data (430) to remove the private data and combining the data with private key from the secure element (440). Then, system may verify the proof output before sending data to the network (450). Voting organizer only get the main data needed in voting (460).

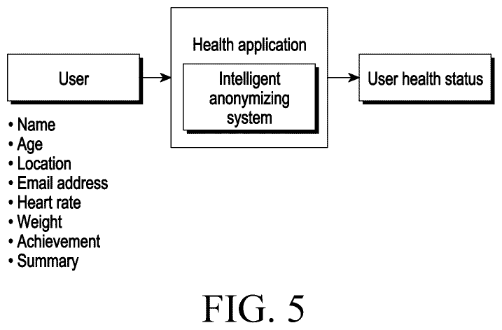

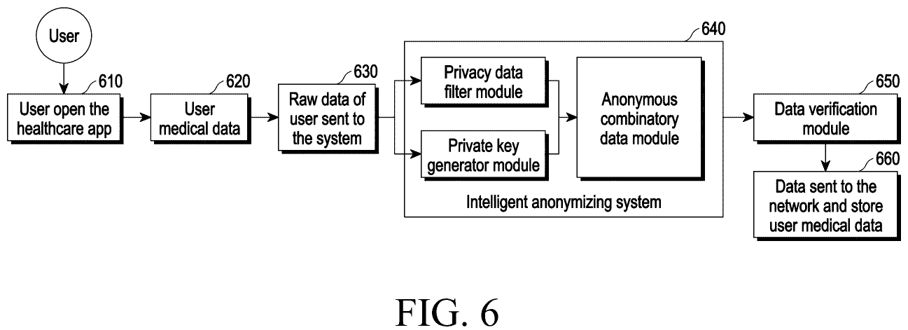

FIG. 5 and FIG. 6 describe the user scenario of using Intelligent Anonymizing System for health application. Health application contains very sensitive personal information of the users, but the organization also need to maintain the data for user preference purposes. According to embodiments of the disclosure, user may be able to use the health application without revealing the identity to the network. FIG. 5 illustrates the scenario when a user is using health application on smartphone to maintain his/her health. Initially, user signed up by creating an account and filling in his/her personal data, such as name, age, location and email address. The application may ask the user to scan/input their health information, such as heart rate and weight before using the application. After all information are collected, user can start to maintain his/her health using the application without the worry of revealing his/her identity to network.

Health application may have a large amount of data to be collected such as user's biodata, heart rate, weight, achievement, summary of activities, and other data. The Intelligent Anonymizing System may be able to filter the data that are considered as private. FIG. 6 illustrates an example of the process when using the system on health application. When a user is using a health application (610), the user may input medical data to the application (620). The system may collect the data from user (630) and filter any ineligible data (640). The system may remove user account data and generate proof for verification (650). After verification, the system may send the clean data to be stored on the health application (660).

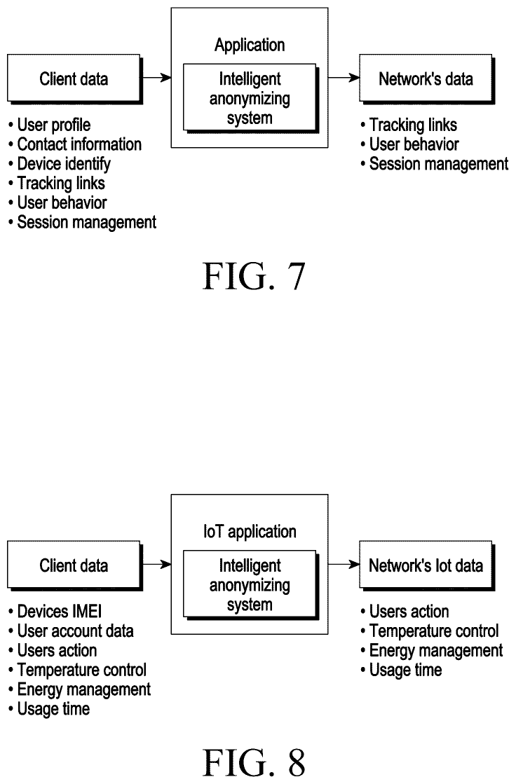

FIG. 7 illustrates an example of the user scenario of using Intelligent Anonymizing System for online advertising. Most online advertising technology may need data from client to be able to display relevant advertisement on user's network. Embodiments of the disclosure provides a solution for users who prefers to receive relevant advertisement without sending personal information to the network. Neither publisher nor advertiser may receive user's private data, but they are still able to reach the intended user targets. FIG. 7, illustrates an example of when a user viewed an advertisement on smartphone. For this case, advertising companies have to collect data such as tracking links, user behavior, session management, user profile, contact information, device identity and etc. Embodiments of the disclosure may collect data from user's behavior and extract the data to remove ineligible data before sending it to the network. The end result is user getting relevant advertisement without revealing private data to the advertisers.

FIG. 8, illustrates an example of the user scenario of using Intelligent Anonymizing System for IoT application. The use of IoT is increasing these days. IoT enables users to control smart devices using application. However, maintaining data while keeping user's privacy safe would be a very challenging task to do for IoT service providers. These providers have to control data from client and securing those data to ensure that there is no data leakage on the network, because it may involve private information that should not be shared. Also, the collected data needs to be verified if it is from real users by performing credential key checking. FIG. 8, illustrates when a user is controlling the IoT devices using application. In general, IoT applications may manage sensor and action data such as user's action, temperature control, energy management, usage time, devices' IMEI, user account data and others. To secure client's data, the system may collect user action and sensor data, and send it to the target network. After information data has been extracted and the verification of user is done, data may be stored to the network. The system may differentiate client data into two components, which are shareable data and private data. After data sent to the network, IoT providers can process the shareable data without fearing the leak of user's private data.

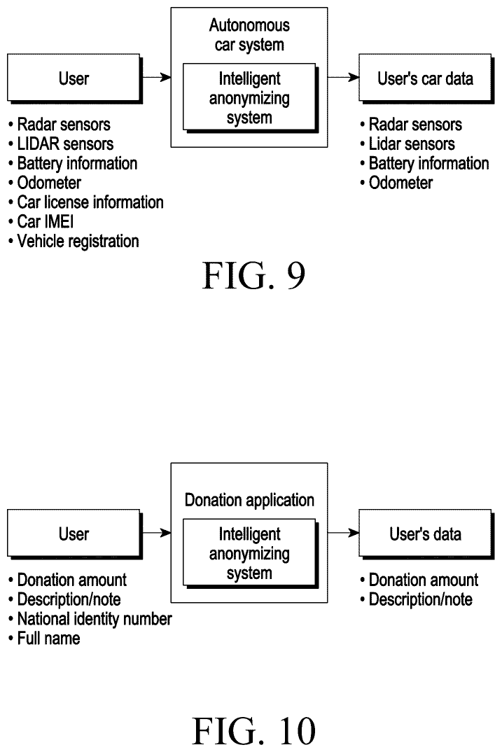

FIG. 9, illustrates an example of the user scenario of using Intelligent Anonymizing System for Autonomous Automobiles. Autonomous cars may receive many data from the sensors embedded on the vehicle. These data are crucial and requires to be obtained quickly. However, some of the data received may include some sensitive information from the client. According to embodiments of the disclosure, system providers may not have to worry about leaking sensitive information because personal information is removed before the data is sent to the network. FIG. 9 illustrates the types of sensor data gathered from an autonomous automobile. For this case, the autonomous automobile may receive data from sensors, such as radar, Light Detection and Ranging (LiDAR), battery information, odometer, car license plate, vehicle registration and other data. The system may filter the data to maintain user's privacy, and verify the main data. The main data is then stored to the network and may be used to train the system provider's Machine Learning system.

FIG. 10 illustrates the user scenario of using Intelligent Anonymizing System for Online Donation. One of the issue with online donation is the difficulty to maintain transparency and anonymity at the same time. According to embodiments of the disclosure, any entity can verify that the donation was received and counted properly without revealing personal information to the network. FIG. 10, illustrates a user making donation using smartphone. For this case, the data collected are amount of money, national identity number, full name and other related data. The system may filter ineligible data from user's input before sent to the network. The end result is the data may be shown transparently and still protect user's credential data.

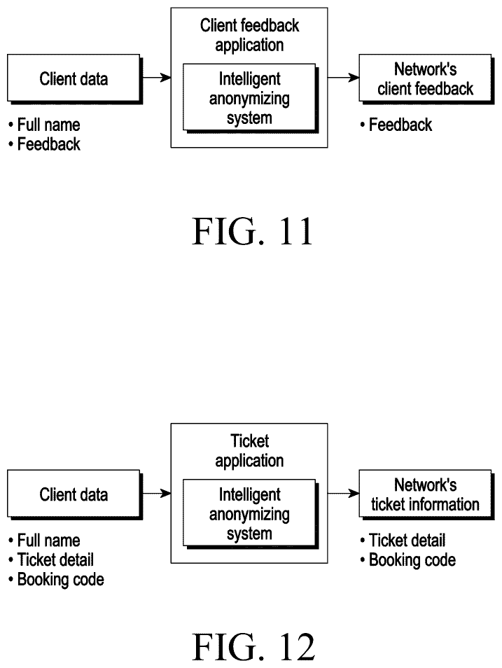

FIG. 11, illustrates an example of the user scenario of using Intelligent Anonymizing System for Anonymous Feedback. Anonymous feedback have an issues to keep the users anonymous, personal information such as phone numbers, email, name and password might be exposed to the company or even unauthorized organization. According to embodiments of the disclosure, any entity may ensure they may not receive any personal information to the network. FIG. 11 illustrates when a user is filling and sending a feedback. To make sure this is a real feedback from real user, user have to give personal information and feedback comment. The private data may be filtered using the system before it is sent to the network. Then, the data may be shown transparently and may not contain any personal information.

FIG. 12 illustrates an example of the user scenario of using Intelligent Anonymizing System for online ticket purchase. When purchasing a ticket to attend an event, the buyer needs to provide personal identification, such as name, email, ticket detail, and booking code. According to embodiments of the disclosure, the system may act as an authenticator by using the Key Generator module and Anonymous Combinatory Data module. Thus, this system can authenticate users without exchanging personal information. FIG. 12 illustrates when a user is attending an event without revealing the ticket information and personal information to the event organizer. After buying or registering for a ticket to the event, user can prove that he/she has a ticket without displaying the personal information, and the event organizer may be able to authenticate that the ticket is real without needing to exchange personal information.

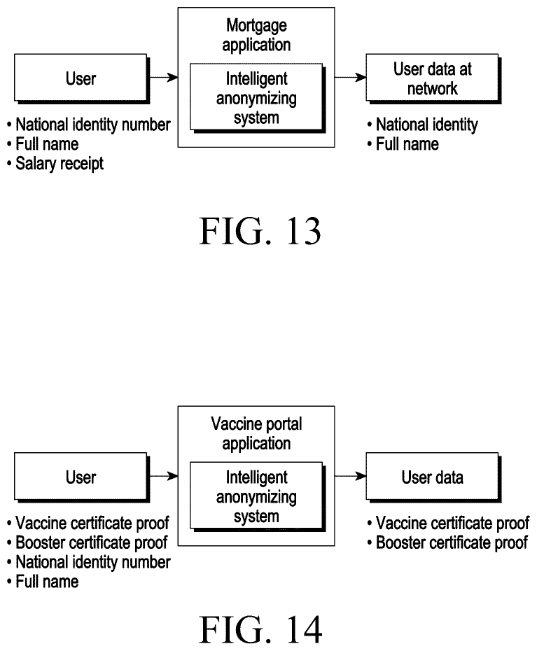

FIG. 13 illustrates an example of the user scenario of using Intelligent Anonymizing System for online mortgage application. When applying for an online mortgage application, user may be required to provide proof of income such as paycheck or filed tax returns to get approval from the bank before receiving the loan. According to embodiments of the disclosure, the bank may be able to verify the mortgage application without revealing any specific data about the paycheck information. As shown in FIG. 13, illustrates when a user applies for mortgage and have to provide national identity number, full name, and proof of paycheck to the bank. The system may run the Filtering Data module for the proof of paycheck. Then, the bank can prove that user income is in the admissible range without revealing the exact salary of the user.

FIG. 14 illustrates an example of the user scenario of using Intelligent Anonymizing System for vaccine check portal. When entering a building or certain places of interest, visitors need to prove their vaccination status and show their vaccine certificate. The certificate may contain personal information such as national identity number, full name, and others. By using this system, visitor can prove that they have been vaccinated without the need to exchange personal information to the authenticator system. FIG. 14 illustrates when a user is using the vaccine check portal application to enter a building or an event. For this scenario, the vaccine check portal application may collect data of vaccine certificate proof, booster certificate proof, national identity number, full name and etc. The system scan the barcode and give the proof data to the system, and filter the information before sending it to the network. The system may then validate if the data is valid without knowing user's personal information.

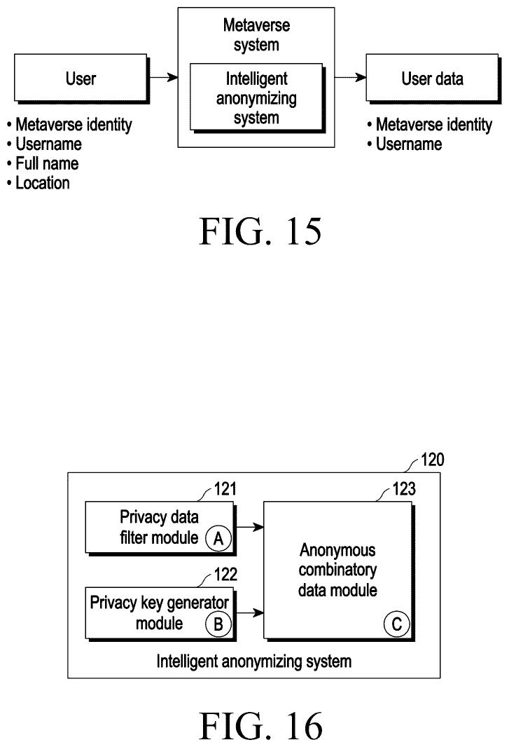

FIG. 15 illustrates an example of the user scenario of using Intelligent Anonymizing System for metaverse pseudo-identity. Metaverse is one of the technologies expected to grow big in the future. However, there is question on how secure the network used by metaverse may be since there are no rules yet for data privacy on metaverse. Embodiments of the disclosure can be implemented as part of the metaverse to ensure secure and private authentication to prove that the real user is behind the metaverse identity without revealing sensitive information and no private data shared to the network. FIG. 15 illustrates when a user is exploring the metaverse. For this case, metaverse is collecting data such as username, full name, location, and other data. When the user joins the metaverse, the system can verify and allow the user to join the metaverse as anonymous and the private data may not be stored in the metaverse network.

FIG. 16 illustrates an example of the main modules of intelligent anonymizing system (120). This system include three main modules, which are a privacy data filter module (121), private key generator module (122), and an anonymous combinatory data module (123). Every software and services that run on smart devices may automatically collect information from their users. All of the collected data may help the service provide to customize user's experience when using the service, such as remembering information inputted by the user and preferred settings so user may feel the same experience every time the user uses the service or application. This also helps to understand the user's behaviors when using the service, measure the functional value of the service, and many more, and it may be used to enhance the service itself. However, the data collection activity of those services should follow the regulation for personal data protection law. Thus, collecting all private data or information of users without user's consent may violate the law. Implementing privacy policy agreements is one of the ways for service provider to avoid potential legal problems. Privacy policy may be a legal document that every service needs to obey and every user needs to agree. By agreeing to privacy policy agreements, both users and service providers can achieve their goals. Agreeing to the privacy policy may mean that users agree that all data or any specified data may be shared to the service provider or other parties. Those data may be kept in the provider's data server, and it is still questionable if there are any private data that are kept explicitly. This way of data collecting behavior can be considered dangerous because the data saved on their system are not protected and human-readable, and it may be a big loss for the users when data breaches happened. A purpose of the intelligent anonymizing system (120) is to ensure that user's data are shared properly and safely. The ineligible private content of the shared data may be filtered by the system. This system may also ensure the data is verified and the verification procedure can be done without the need of knowing the privacy data.

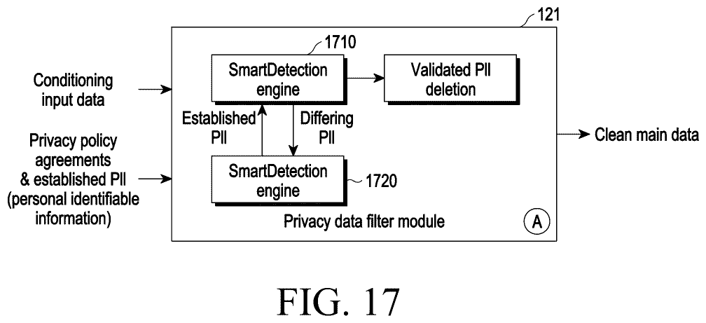

FIG. 17 to FIG. 19B shows the privacy data filter module (121). This is the first process mechanism that is used for filtering and removing data considered as private, by applying the privacy policy agreements. The system requires input data, privacy policy agreements and established personal identifiable information (PII). FIG. 17 show the process for the privacy data filter module. Conditioning input data is the process of equating some of the data characteristics so that different types of data can be standardized, while privacy policy agreements provided rules to determine which data is categorized as personal information, and established PII provides data for initialization of PII model. At the first step of the process, a smart detection engine (1710) may identify PII based on the privacy policy agreements. The smart detection engine (1710) may scan the input data to identify which part of data to be considered as PII. Then, the smart detection engine (1710) may validate the identified PII and produce validated PII. To validate the identified PII data, the smart detection engine (1710) may compare the identified PII by checking its similarity with the established PII provided between the smart detection engine (1710) and reference data storage (1720).

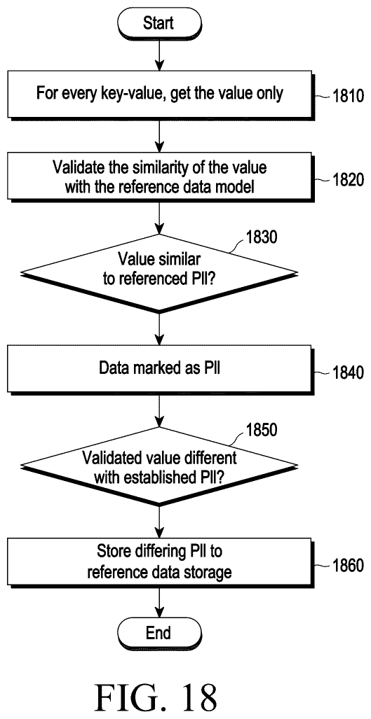

FIG. 18 illustrates an example of the process for PII validation. For every key-value, only the value is obtained (1810). The similarity of the value with the reference data model is validated (1820). It is determined whether the value is similar to the reference PII (1830). The similarity to PII is identified by calculating the score of the checked value, based on a specified Machine Learning algorithm. If the checked value is classified as PII, the data may be marked as validated PII (1840). If it is not, the value can be ignored. In the process, validated PII may have differences with the established PII, to create differing PII (1850). The differing PII may be sent to Reference Data Storage to update established PII (1860). Then, after Validated PII is marked, it may be deleted and may not contain PII anymore, thus producing clean main data.

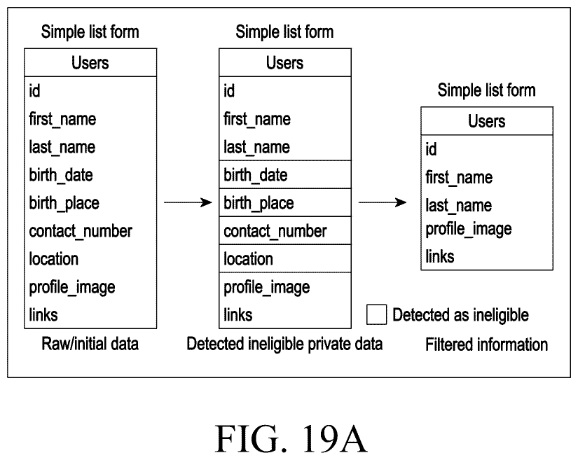

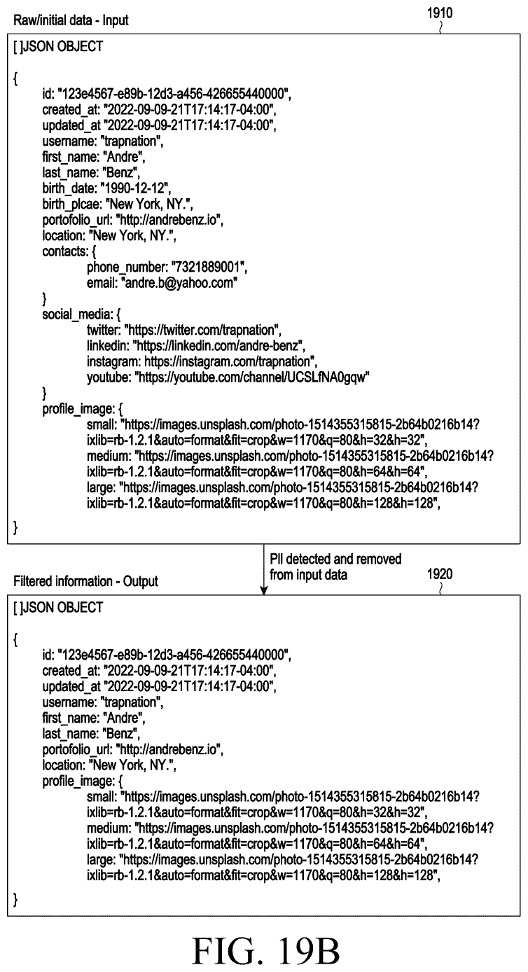

FIG. 19A and FIG. 19B show the example of how the private data is detected and removed in two different data formats, which are the simple list form (a) (1910) and JSON object form (b) (1920). The privacy data filter module (121) may accept the data from user and start to detect ineligible part of the PII. The original data may be filtered by removing fields that are detected as PII.

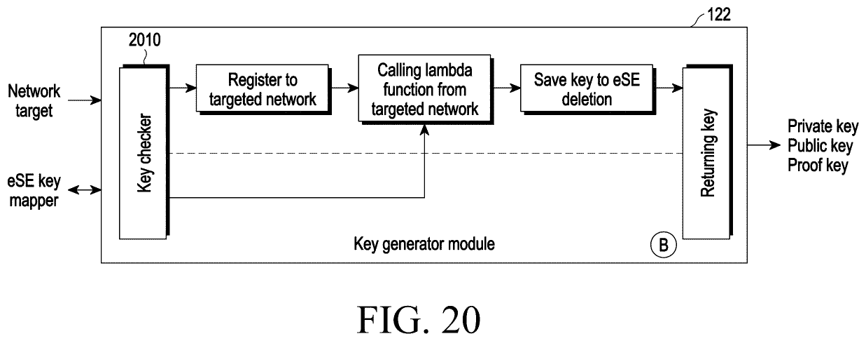

FIG. 20 to FIG. 26 illustrate examples of the private key generator module (122). The private key generator module (122) is used to store and prepare the keys needed in the verification process. The system may communicate with embedded secure element (eSE) to configure and save the secret key. There are at least three keys that may be stored in eSE. The first key is the public key, used as a user identifier on the targeted network. The next key is the private key, a key pairing to the public key that must be kept secret. The public key and private key are a pair of keys used in asymmetric encryption. The asymmetric encryption uses a private key to encrypt data and decrypt data using a public key. The public key and private key are used for the user validation process on the targeted network. The third key is the proof key, a set of data used for the process of making proof output. FIG. 20 describes the flow to configure and save secret key. At the beginning of the process, this module may check the availability of private key and public key in eSE. The module in the Key Checker procedure (2010) may check the availability of private keys and public keys in eSE. The checking process aims to find out whether the device has been registered on the targeted network or not, as the public and private keys are obtained when the device has been registered on the targeted network. If the private key and public key are not in the eSE, the module needs to register the device to the targeted network according to the procedure. If the private key and public key are in the eSE, it indicates that the device has been registered on the targeted network.

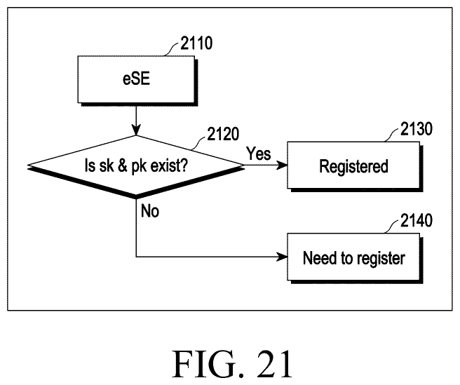

FIG. 21 describes the process for key checker procedure. The key checker procedure may include identifying whether the secret key (i.e. private key) and the public key exist (2120) by referring to the eSE (2110), if the secret key and the public key exist, determining that the device has been registered to the target network (2130), and if the secret key and the public key do not exist, determining that the device needs to be registered to the target network (2140). Registration to targeted network is executed when the device is not registered on the targeted network. The targeted network must contain data only from eligible devices. One way to filter out who can register on the intended network is to use a Predefined ID. Predefined ID is a device identifier that was defined when the data was created. Predefined ID are stored in eSE. Predefined ID must be unique, able to identify eligible device, and hard to guess. To meet these criteria, a Predefined ID can be generated using an encryption. The owner of the targeted network needs to create a unique ID for each user, for example ‘Device123’. After that, the ID is encrypted with a secret key, which only the owner of the targeted network knows. Encryption can prevent Predefined ID from being difficult to guess. The result of this encryption may be the Predefined ID that is stored in eSE. The following is an example of creating Predefined ID:

Predefined ID = EnC(‘Device123’, Enc Key)
Predefined ID = b000fd0d562c45 ...
Predefined ID = Dec(b000fd0d562c45 ..., Dec Key)
Predefined ID = ‘Device123’

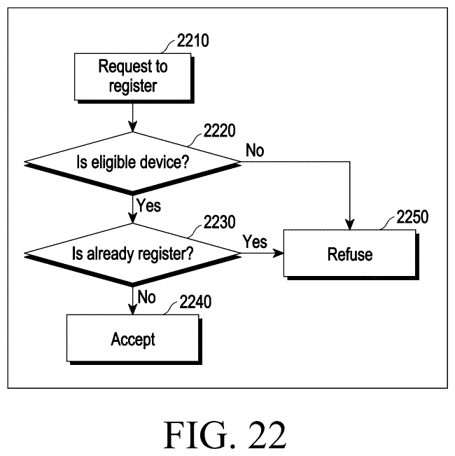

The Predefined ID checking process is carried out on the targeted network. Predefined ID needs to be decrypted and then checked whether the result of the decryption matches the ID provided by the owner of the targeted network. FIG. 22 describes the checking process flow. In addition to checking eligible devices, the system also needs to check whether the device has been registered on the targeted network. This process aims to avoid data duplication from the same device. The checking process may be performed by an apparatus in the target network. The checking process may include receiving a request to register from a device (2210), determining whether the device is an eligible device (2220), if the device is the eligible device, determining whether the device is already registered (2230), if the device is not already registered, accepting the request (2240), and if the device is not the eligible device or if the device is already registered, refusing the request (2250).

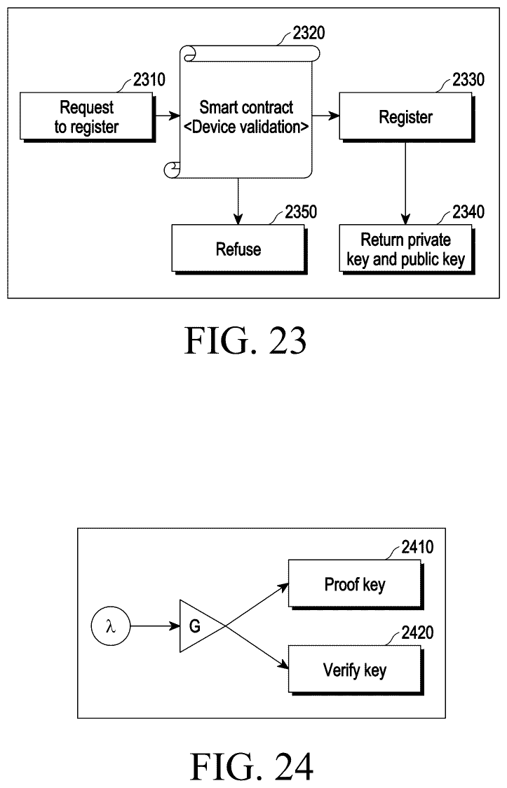

FIG. 23 shows the process for network registration. The process for network registration may include receiving the request to register from the device (2310), determining whether the device is validated using a smart contract (2320), if the device is validated, determining to register the device (2330) and returning the private key and the public key (2340), and if the device is not validated, refusing the request (2350). The smart contract can be implemented in the apparatus in the target network, for the checking process. After passing the checking process, the device may be registered to targeted network and targeted network may return the private key and public key.

FIG. 24 shows the process for calling Lambda Function. After the device is registered on the targeted network, the Device executes the Calling Lambda function from targeted network procedure. Lambda Function is a function that is used to generate a proof key (2410) and verify key (2420) from a randomly selected secret parameter. Proof key and verify key may be used in the verification process.

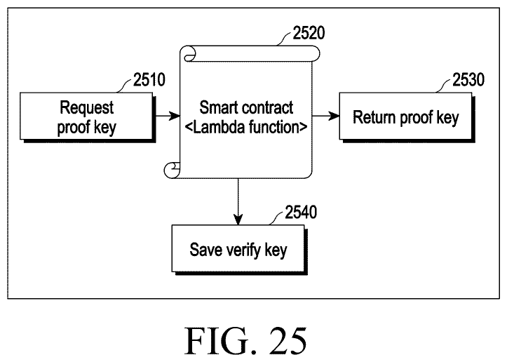

FIG. 25 shows the process flow for implementing Lambda Function using smart contracts. The process flow for implementing Lambda Function may include receiving a request for the proof key (2510), calling Lambda Function using the smart contract (2520), returning the proof key obtained from the Lambda Function (2530), and saving the verify key obtained from the Lambda Function (2540). When the user runs the Lambda Function, the user may receive a proof key and the verify key may be stored in the smart contract for the verification process. After the keys are generated, the next step is the Save key to eSE procedure.

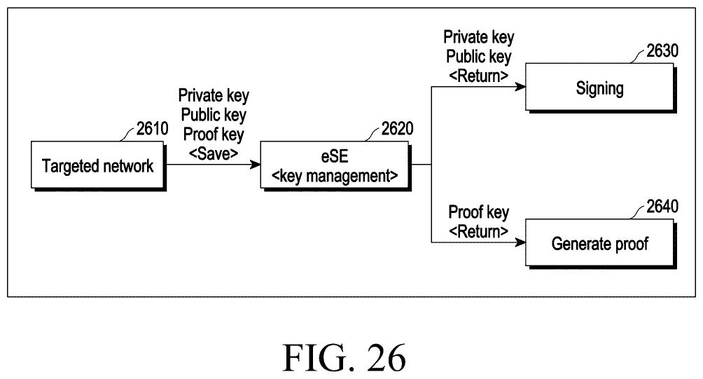

FIG. 26 shows the flow diagram to save and return the keys to eSE. The private key, public key, and proof key generated by the targeted network (2610) may be stored in eSE (2620) using the key management function. The eSE (2620) may return the value of keys when there is a process that requires these keys, for example, returning the private key and the public key for signing data (2630) and returning the proof key for generating proof (2640).

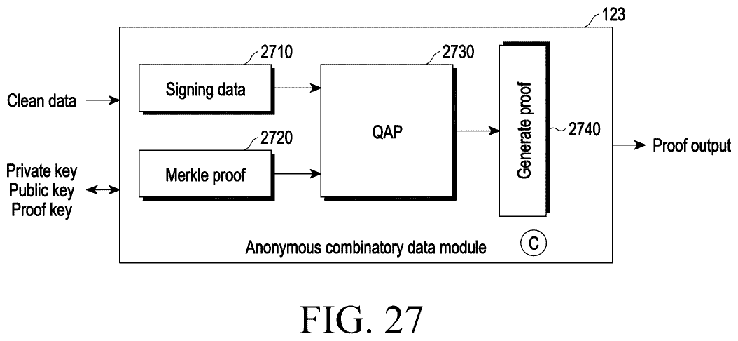

FIG. 27 to FIG. 33 illustrate examples of the anonymous combinatory data module (123). The anonymous combinatory data module (123) is used to process and combine data and key to form proof data. There are two proof outputs, namely signing data (2710) and Merkle proof (2720). The purpose of signing data is (2710) to ensure if the sender of the data is valid. A valid sender may have the correct private key and public key. The purpose of Merkle proof (2720) is to check if the data belongs to a blockchain network. As shown in FIG. 27, the anonymous combinatory data module (123) may process the clean data and generated keys separately. First, the clean data, private key, and public key may enter to the signing data procedure to make the output proof of the signing data. The public key, signing data, and hash clean data are needed to verify if someone is valid on the blockchain network. Signing data (2710) is the combination of hash clean data and private key. Public keys and private keys are already available on eSE. Before signing, the clean data needs to be hashed. The hash data may be signed with the private key. The signing process can be done in eSE to maintain the security of the private key.

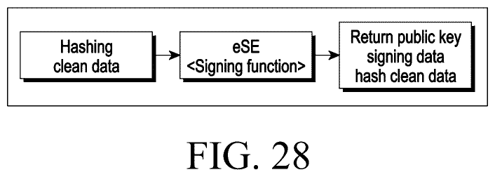

FIG. 28 illustrates an example of the signing process. In general, checking for signing data may be done using the following formula:

$$Dec ( Signing Data , Public Key = Hash Clean Data$$

The private key and public key are a pair of keys from the Asymmetric Encryption process that may enable the checking of private key ownership. If the data sent by the user meets these conditions, the system may decide if the user has the private key paired with the public key sent to the blockchain network. Besides checking data signing, another procedure is checking the Merkle proof. Merkle proof is a method of proving membership using a Merkle tree. Merkle tree is a way of organizing and structuring large amounts of data to make it easier to process. Merkle tree is a Hierarchical Hash. The leaf node of the Merkle tree is the result of hashing the blockchain data. Non-Leaf node of Merkle tree is a combination of hashing the branches. The root of the Merkle tree is commonly called the Merkle root. Merkle tree is used to ensure that the data on the blockchain is not altered. Merkle tree can also be used to determine which data is part of a blockchain network, commonly known as Merkle proof. The blockchain network may provide sibling of the data path that wants to be proved.

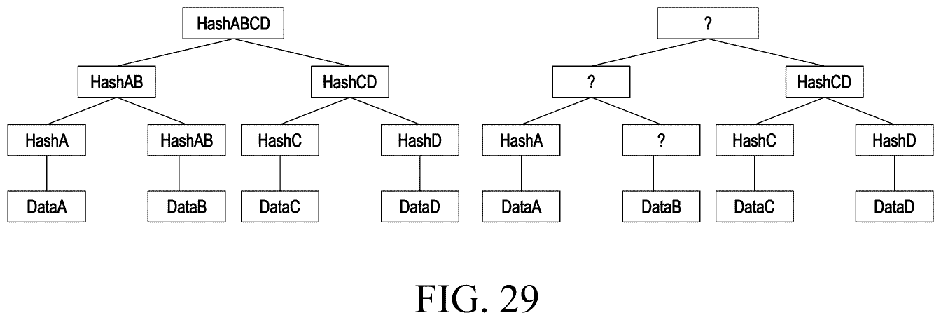

FIG. 29 illustrates an example of the sibling during the Merkle proof process. Proofer are asked to determine the exact value of the data path traversed. If the results matched the actual Merkle tree, then the data is part of the blockchain network. However, this method still assigns the value of the public key and path of data in Merkle tree to the targeted network.

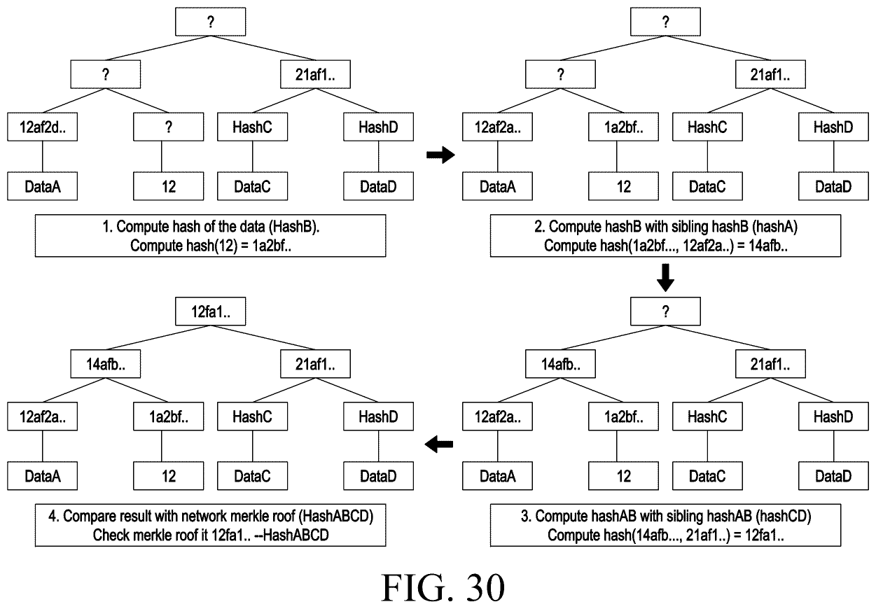

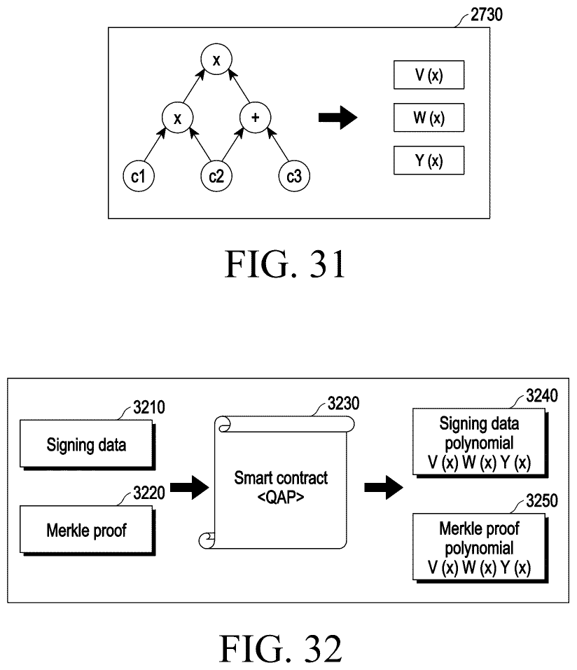

FIG. 30 illustrates the example of Merkle proof process in the system. In order to keep the user's identity anonymous, a method to hide the public key and path of data in Merkle tree that can still be proven is required. The method that can be used is Zero Knowledge Proof (ZKP). ZKP is a verification method where the verifier can verify the proofer without knowing the proofer's privacy data. In this module, the system may use Quadratic Arithmetic Program (QAP), Homomorphic Encryption, and Pinocchio Protocol to build the ZKP method. FIG. 31 shows the QAP process (2730) in FIG. 27. After the module generates signing data (2710) and Merkle proof (2720), the next step is to enter the QAP procedure (2730). QAP (2730) is the process of changing the form of computation or arithmetic circuits into polynomial form. QAP converts computation or arithmetic circuits from data signing and Merkle proofs to polynomial form. This procedure produces three polynomials V(x), W(x), and Y(x). These polynomials may be used in the proof generation procedure, especially in the Pinocchio Protocol. FIG. 32 shows the implementation of QAP using smart contract. The smart contract (3230) generates the signing data polynomial (3240) and the Merkle proof polynomial (3250) from the signing data (3210) and Merkle proof (322) through the QAP.

After QAP process (2730), polynomial is entered to the generate proof procedure (2740). Generate proof procedure (2740) uses Pinocchio Protocol as the basis for making proof. Pinocchio is a system built to efficiently verify general computations while relying only on cryptographic assumptions. The Pinocchio Protocol utilizes the concepts of Polynomial and Homomorphic Encryption (E) to create an efficient verification system. The following are the stages of the Pinocchio protocol:
Verifier (Network)
Construct target polynomial (x) with the claimed roots.
Select random s value.
Evaluate(s) and send to the prover the encryptions (s0), (s), . . . E(sd).
Proofer (Device)

$$Compute P ( x ) = V ( x ) ⋆ W ( x ) - Y ( x )$$

$$Compute H ( x ) = P ( x ) / t ( x )$$

Evaluate E(P(s)) or E(V(s)), E(W(s)), E(Y(s)), E(H(s)) and return them to the verifier
Verifier (Network)

$$Check if the following equation holds : ( ( s ) ) = ( H ( s ) ⋆ t ( s ) )$$

where:
V(x), W(x), Y(x)=Polynomial from QAP process.
p(x)=Polynomial proof statement.
t(x)=Target Polynomial with claimed root to p(x).
s=Secret parameter, generated randomly.
E(x)=encrypt value x with Homomorphic Encryption.

The stages of using Homomorphic Encryption makes it possible to evaluate a polynomial without the verifier knowing the contents of (x) or the proofer knowing the contents of s. This is because the value encrypted using homomorphic encryption can perform computations without the need for a decryption process.

The problem with the Pinocchio protocol is that the verifier can obtain information from the hiding information provided by the proofer. In the generate process, the proofer may submit E(V(s)), E(W(s)), E(Y(s)), E(H(s)) to verifier. Since the verifier knows the value of s, verifier can create a polynomial V′(s), W′(s), Y′(s), H′(s) then encrypt it to E(V′(s)), E(W′(s)), E(Y′(s)), E(H′(s)). Verifier can compare the value of verifier's encryption polynomial with proofer's encryption polynomial. If the values are different, then verifier may know the verifier's polynomial is not the same as the proofer's polynomial and vice versa. To avoid such information leakage, proofer may conceal the assignment by adding a “random t-shift” to each polynomial. That is, proofer chooses random δ1, δ2, δ3, and defines:

$$Vz ( x ) = V ( x ) + δ 1 ⋆ t ( x )$$

$$Wz ( x ) = W ( x ) + δ 2 ⋆ t ( x )$$

$$Yz ( x ) = Y ( x ) + δ 3 ⋆ t ( x )$$

$$\begin{matrix}Hz ( x ) = \frac{Vz ( x ) ⋆ Wz ( x ) - Yz ( x )}{t ( x )} \\ = \frac{V ( x ) ⋆ W ( x ) - Y ( x )}{t ( x )} + ( V ( x ) ⋆ δ 2 + W ( x ) ⋆ δ 1 + δ 1 ⋆ δ 2 ⋆ T - δ 3\end{matrix}$$

$$Hz ( x ) = H ( x ) + ( V ( x ) ⋆ δ 2 + W ( x ) ⋆ δ 1 + δ 1 ⋆ δ 2 ⋆ T - δ 3 )$$

Where:
Vz(x), Wz(x), Yz(x)=Hiding polynomial of V(x), W(x), Y(x)
δ1, δ2, δ3=Random value for Hiding polynomial process.

In this way, the information can be masked because the data is wrapped with random values. These changes may still be accepted by the verifier. Following is a mathematical proof why the change in the value of the polynomial is still acceptable to the verifier:

$$Vz ( x ) ⋆ Wz ( x ) − Yz ( x ) = t ( x ) ⋆ Hz ( x )$$

$$V ( x ) + δ 1 ⋆ t ( x ) ) ⋆ ( W ( x ) + δ 2 ⋆ t ( x ) ) − ( Y ( x ) + δ 3 ⋆ t ( x ) ) = t ( x ) ⋆ ( H ( x ) + ( V ( x ) ⋆ δ 2 + W ( x ) ⋆ δ 1 + δ 1 ⋆ δ 2 ⋆ {T ( x )}^{2} − δ 3 ) )$$

$$( V ( x ) ⋆ W ( x ) − Y ( x ) + ( V ( x ) ⋆ t ( x ) ⋆ δ 2 + W ( x ) ⋆ t ( x ) ⋆ δ 1 + δ 1 ⋆ δ 2 ⋆ {T ( x )}^{2} − δ 3 ) = ( t ( x ) ⋆ H ( x ) ) + ( V ( x ) ⋆ t ( x ) ⋆ δ 2 + W ( x ) ⋆ t ( x ) ⋆ δ 1 + δ 1 ⋆ δ 2 ⋆ {T ( x )}^{2} − δ 3 )$$

$$( V ( x ) ⋆ W ( x ) - Y ( x ) ) + \text{?} \text{?} = ( t ( x ) ⋆ H ( x ) ) \text{?} \text{?}$$

$$V ( x ) ⋆ W ( x ) - Y ( x ) = t ( x ) ⋆ H ( x )$$

As long as the polynomial satisfies (x)*W(x)−Y(x)=t(x)*H(x), then the polynomial is valid and can be accepted by the verifier. Based on the method described previously, the following are the steps to generate proof in the generate proof procedure:

$$Proof Key = ( \{ E ( vk ( s ) ) , E ( wk ( s ) ) , E ( yk ( s ) ) , E ( α vk ( s ) ) , E ( α wk ( s ) ) , E ( α yk ( s ) ) \} k ∈ [ n ] , \{ E ( sj ) \} j ∈ [ d ] )$$

where n is number of variable and dis highest degree in polynomial.

### Construct H(x):

$$P ( x ) = V ( x ) ⋆ W ( x ) - Y ( x )$$

$$H ( x ) = P ( x ) / t ( x )$$

### Construct(x), Wz(x), Yz(x), Hz(x):

$$Vz ( x ) = V ( x ) + δ 1 ⋆ t ( x )$$

$$Wz ( x ) = W ( x ) + δ 2 ⋆ t ( x )$$

$$Yz ( x ) = Y ( x ) + δ 3 ⋆ t ( x )$$

$$Hz ( x ) = H ( x ) + ( V ( x ) ⋆ δ 2 + W ( x ) ⋆ δ 1 + δ 1 ⋆ δ 2 ⋆ T - δ 3 )$$

Compute E(Hz(s)) using {E(sj)}j∈[d] from proof key.
Compute E(Vz(s)), E(Wz(s)),E(Yz(s)),E(αVz(s)),E(αWz(s)),E(αYz(s)) using proof key.

$$Proof Output = ( ( E ( Vz ( s ) ) , E ( Wz ( s ) ) , E ( Yz ( s ) ) , E ( α Vz ( s ) ) , E ( α Wz ( s ) ) , E ( α Yz ( s ) ) , E ( Hz ( s ) ) )$$

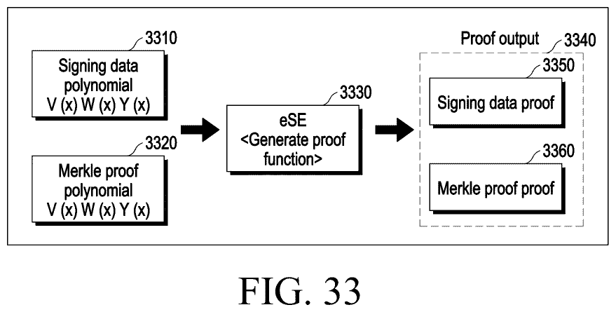

FIG. 33 shows the process for generating proof output inside eSE. Using a generate proof function, the eSE (3330) generates the proof output (3340) including the signing data proof (3350) and the Merkle proof proof (3360) from the signing data polynomial (3310) and the Merkle proof polynomial (3320). This proof output data may be sent to the targeted network for verification.

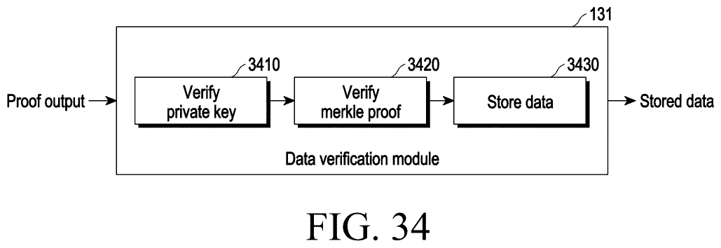

FIG. 34 to FIG. 36 illustrates examples of the data verification process. The data verification module (131) is a separate module that may may be executed externally from the device. The data verification module (131) contains procedures for verification and data stores. The implementation of this module can use smart contracts that can be created on the targeted network. FIG. 34 describes the data verification module (131), used to verify the eligibility of the encrypted data. The output data from this module can be stored into the storage (3430). There may be sequential checking procedure in this module. The first checking (3410) is to check whether the user is the holder of the private key using signing data proof. The second checking (3420) is to ensure the user is part of the targeted network using Merkle proof. Proof output from anonymous combinatory data module (123) may enter the data verification module (131). The verification process is still connecting processes from the Pinocchio Protocol. Following are the verification steps:

### Input:

$$Signing Data Proof = ( ( E ( Vz ( s ) ) , E ( Wz ( s ) ) , E ( Yz ( s ) ) , E ( α Vz ( s ) ) , E ( α Wz ( s ) ) , E ( α Yz ( s ) ) , E ( Hz ( s ) ) )$$

$$Verify Key = ( E ( α ) , E ( t ( s ) )$$

$$Evaluated is E ( Vz ( s ) ) ⋆ E ( W ( s ) = E ( Hz ( s ) ) ⋆ t ( s ) ) ⋆ E ( Yz ( s ) )$$

$$Evaluated is E ( Vz ( s ) ) ⋆ E ( α ) = E ( α Vz ( s ) )$$

$$Evaluated is E ( Wz ( s ) ) ⋆ E ( α ) = E ( α Wz ( s ) )$$

$$Evaluated is E ( Yz ( s ) ) ⋆ E ( α ) = E ( α Yz ( s ) )$$

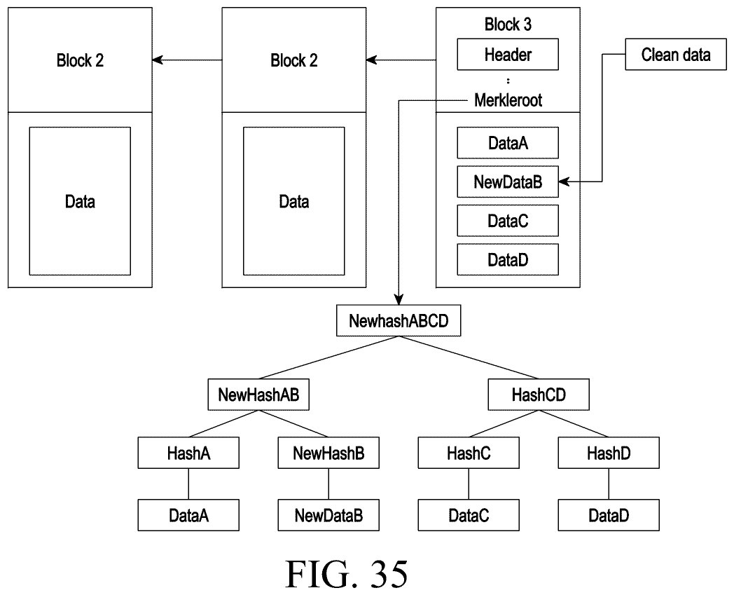

FIG. 35 illustrates an example of the process for adding new data to targeted network. If all of the evaluation processes are correct, then the verification process is successful or passes. When all verification processes have passed, user data may be added to the targeted network by miners.

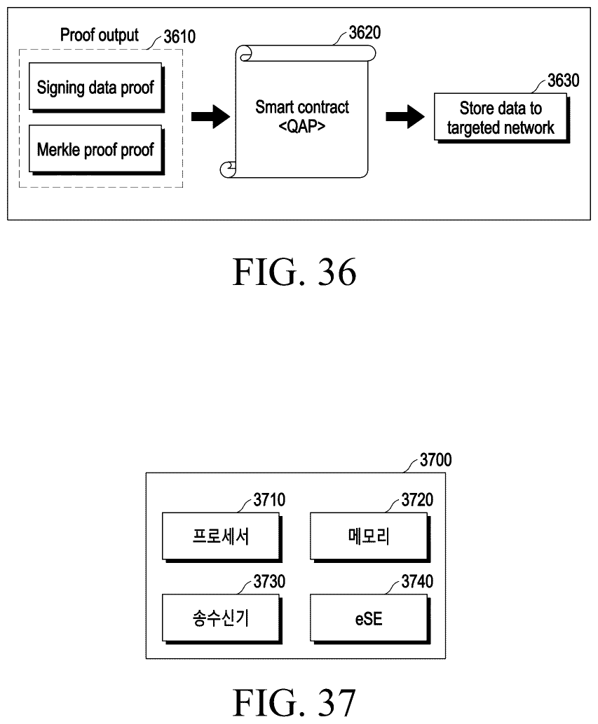

FIG. 36 shows that the verification process can be implemented with smart contract. The smart contract (3620) verifies the proof output (3610) thhrough the data verification process, and storing the output data (3630) from the data verification process.

FIG. 37 shows a block diagram of an electronic device of the present disclosure. The electronic device (3700) may include at least one processor (3710), a memory (3720), a communicator (3730) and an eSE (3740).

The memory (3720) may be configured to store instructions to be executed by the at least one processor (3710). The memory (3720) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (3720) may, in some examples, be considered a non-transitory storage medium. The term “non-transitory” may indicate that the storage medium is not embodied in a carrier wave or a propagated signal. However, the term “non-transitory” should not be interpreted as meaning that the memory (3720) is non-movable. In various examples, the memory (3720) can be configured to store larger amounts of information. In various examples, a non-transitory storage medium may store data that can, over time, change (e.g., in Random Access Memory (RAM) or cache).

The at least one processor (3710) (including, e.g., processing circuitry) communicates with the memory (3720), the communicator (3730) and the eSE (3740). The at least one processor (3710) may be configured to execute instructions stored in the memory (3720) and to perform various processes. The at least one processor (3710) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The functions of the modules described herein may be performed by the at least one processor (3710) executing the instructions stored in the memory (3730).

The communicator (3730) includes an electronic circuit specific to a standard that enables wired or wireless communication. The communicator (3730) is configured to communicate internally between internal hardware components of the electronic device (3700) and with external devices via one or more networks.

Embodiments of the disclosure proposes a novel method that provides an Intelligent Anonymizing System using devices that has processor, network access, and eSE to filter data considered as private, generate keys, encrypt the data using private key and the specified algorithm, and verify the eligibility of the data using zero knowledge proof.

Embodiments of the disclosure may perform several activities. The first is to generate and store user's secret key safely in eSE. This may allow the private data to be kept from being collected or shared when there is no consent from users. Additionally, the system may run an encryption process to enable the sharing of data from user's devices to others, i.e. third parties, without exposing the whole data explicitly. The system may also be able to verify the shared data without the need of the explicit and original content of the data. Embodiments of the disclosure also function as authentication and identification for payment, digital key access, e-government, and others.

To perform all of the activities above, the system according to embodiments may include of four main modules. The first module is Privacy Data Filter module, used for filtering and removing private data by applying privacy policy agreements. The second module is Private Key Generator module, used for generating private key, public key, and pairing keys, which consist of proof key and verification key. All generated keys may be stored in the eSE. The third module is Anonymous Combinatory Data module, used for processing data and transform it into encrypted form using private key and the specified algorithm. The last module is Data Verification module, used to verify the encrypted data, whether the data is eligible or not, using the Zero Knowledge Proof.

In addition, embodiments of the disclosure have the advantage of protecting ineligible user data for being shared to other parties by filtering and verifying the data.

By combining the processes described above, the system can do verification process while keeping the private data into a single procedure. All of the data sent to the network is only the eligible data that can be collected and shared by others. Blockchain technology on targeted network keeps data safe and immutable. This ensures that the user data is the original data of the user. Network owners can use users' data freely because the data does not contain privacy data and there is no need to worry if there is fake data. In addition, the data storage process uses Zero Knowledge Proof, making the verification process on the targeted network anonymous. The Targeted Network can ensure that the incoming data is data from a valid user, but they do not know who sent it. This makes users feel safe because their data is not used for things that can threaten their privacy. The system also makes it difficult for others to trace the data back to the user behind that data in the targeted network. By implementing embodiments of the disclosure on a larger scale and global network, embodiments of the disclosure may make the information sharing between users and service providers more secure and safe.

1. A method for communication by an electronic device in a blockchain network, the method comprising:
obtaining input data;
filtering the input data to remove private data from the input data, based on privacy policy agreements;
obtaining a public key, a private key, and a proof key;
generating an output proof corresponding to signing data based on the filtered input data, the public key, the private key, and the proof key; and
transmitting the output proof to a target network.

2. The method of claim 1, wherein the obtaining the public key, the private key, and the proof key comprises:
determining whether the public key, the private key, and the proof key are stored in an embedded secured element (eSE) included in the electronic device;
based on determining that the public key, the private key, and the proof key are stored in the eSE, obtaining the public key, the private key, and the proof key from the eSE; and
based on determining that the public key, the private key, and the proof key are not stored in the eSE:
transmitting a registration request to the target network,
receiving the public key, the private key, and the proof key from the target network based on a registration to the target network, and
storing the received public key, the received private key, and the received proof key in the eSE.

3. The method of claim 2, wherein the proof key is generated using a Lambda function based on a verification key.

4. The method of claim 1, wherein the generating the output proof comprises:
hashing the filtered input data; and
generating the signing data by signing the hashed filtered input data using the private key.

5. The method of claim 4,
wherein the generating of the output proof further comprises:
generating a signing data polynomial based on the signing data and a Merkle proof polynomial based on a Merkle proof using a quadratic arithmetic program (QAP); and
generating a signing data proof and a Merkle proof proof based on the signing data polynomial and the Merkle proof polynomial using a Pinocchio protocol, and
wherein the output proof comprises the signing data proof and the Merkle proof proof.

6. The method of claim 1, wherein the output proof is generated using an embedded secured element (eSE) included in the electronic device.

7. The method of claim 1, wherein filtering the input data comprises:
identifying personal identifiable information (PII) included in the input data;
validating the identified PII based on a comparison between the identified PII and established PII; and
removing the validated PII from the input data.

8. An electronic device for communication in a blockchain network, the electronic device comprising:
at least one processor; and
memory storing instructions which, when executed by the at least one processor, individually or collectively, cause the electronic device to:
obtain input data;
filter the input data to remove private data from the input data, based on privacy policy agreements;
obtain a public key, a private key, and a proof key;
generate an output proof corresponding to signing data based on the filtered input data, the public key, the private key, and the proof key; and
transmit the output proof to a target network.

9. The electronic device of claim 8, wherein to obtain the public key, the private key, and the proof key, the instructions, when executed by the at least one processor, individually or collectively, further cause the electronic device to:
determine whether the public key, the private key, and the proof key are stored in an embedded secured element (eSE) included in the electronic device;
based on determining that the public key, the private key, and the proof key are in the eSE, obtaining the public key, the private key and the proof key from the eSE; and
based on determining that the public key, the private key, and the proof key are not stored in the eSE:
transmit a registration request to the target network,
receive the public key, the private key, and the proof key from the target network based on a registration to the target network, and
store the received public key, the received private key, and the received proof key in the eSE.

10. The electronic device of claim 9, wherein the proof key is generated using a Lambda function based on a verification key.

11. The electronic device of claim 8, wherein to generate the output proof, the instructions, when executed by the at least one processor, individually or collectively, further cause the electronic device to:
hash the filtered input data; and
generate the signing data by signing the hashed filtered input data with the private key.

12. The electronic device of claim 11,
wherein to generate the output proof, the instructions, when executed by the at least one processor, individually or collectively, further cause the electronic device to:
generate a signing data polynomial based on the signing data and a Merkle proof polynomial based on a Merkle proof using a quadratic arithmetic program (QAP);
generate a signing data proof and a Merkle proof proof based on the signing data polynomial and the Merkle proof polynomial using a Pinocchio protocol, and
wherein the output proof comprises the signing data proof and the Merkle proof proof.

13. The electronic device of claim 9, wherein the output proof is generated using the eSE.

14. The electronic device of claim 9, wherein to filter the input data, the instructions, when executed by the at least one processor, individually or collectively, further cause the electronic device to:
identifying personal identifiable information (PII) included in the input data;
validating the identified PII based on a comparison between the identified PII and established PII; and
removing the validated PII from the input data.

15. A non-transitory computer readable storage medium storing instructions which, when executed by at least one processor of an electronic device, individually or collectively, cause the electronic device to:
obtain input data;
filter the input data to remove private data from the input data, based on privacy policy agreements;
obtain a public key, a private key, and a proof key;
generate an output proof corresponding to signing data based on the filtered input data, the public key, the private key, and the proof key; and
transmit the output proof to a target network.

16. The non-transitory computer readable storage medium of claim 15, wherein to obtain the public key, the private key, and the proof key, the instructions, when executed by the at least one processor, individually or collectively, further cause the electronic device to:
determine whether the public key, the private key, and the proof key are stored in an embedded secured element (eSE) included in the electronic device;
based on determining that the public key, the private key, and the proof key are in the eSE, obtaining the public key, the private key and the proof key from the eSE; and
based on determining that the public key, the private key, and the proof key are not stored in the eSE:
transmit a registration request to the target network,
receive the public key, the private key, and the proof key from the target network based on a registration to the target network, and
store the received public key, the received private key, and the received proof key in the eSE.

17. The non-transitory computer readable storage medium of claim 16, wherein the proof key is generated using a Lambda function based on a verification key.

18. The non-transitory computer readable storage medium of claim 15, wherein to generate the output proof, the instructions, when executed by the at least one processor, individually or collectively, further cause the electronic device to:
hash the filtered input data; and
generate the signing data by signing the hashed filtered input data with the private key.

19. The non-transitory computer readable storage medium of claim 18,
wherein to generate the output proof, the instructions, when executed by the at least one processor, individually or collectively, further cause the electronic device to:
generate a signing data polynomial based on the signing data and a Merkle proof polynomial based on a Merkle proof using a quadratic arithmetic program (QAP);
generate a signing data proof and a Merkle proof proof based on the signing data polynomial and the Merkle proof polynomial using a Pinocchio protocol, and
wherein the output proof comprises the signing data proof and the Merkle proof proof.

20. The non-transitory computer readable storage medium of claim 15, wherein the output proof is generated using the eSE.
